(19) United States
(12) Patent Application Publication
(10) Pub. No.: US 2019/0286825 A1
(43) Pub. Date: Sep. 19, 2019

(54) AUTOMATED WORKFLOW MANAGEMENT AND MONITORING OF DATACENTER IT SECURITY COMPLIANCE

(71) Applicant: Dell Products L.P., Round Rock, TX (US)

(72) Inventors: Viswanath PONNURU, Bangalore (IN); Prasoon Kumar SINHA, Bangalore (IN); Alaric Joaquim Narcissius SILVEIRA, Austin, TX (US)

(73) Assignee: Dell Products L.P., Round Rock, TX (US)

(21) Appl. No.: 15/921,999

(22) Filed: Mar. 15, 2018

(51) Int. Cl. G06F 21/57; H04L 29/06; G06F 11/36; H04L 9/08; G06F 8/65

(52) U.S. Cl. CPC G06F 21/577; H04L 63/20; H04L 63/18; G06F 8/65; G06F 11/3692; H04L 9/0891; G06F 11/3688

(57) ABSTRACT

An information handling system may include at least one processor, a non-transitory memory, and an information handling resource communicatively coupled to the at least one processor. The information handling system may be configured to receive a compliance template that includes security attributes of the information handling resource, the security attributes including information regarding the encryption key; based on the compliance template and a compliance standard, determine a set of compliance tests for the information handling resource; execute the set of compliance tests; and in response to a failure of at least one test of the set of compliance tests, provide an indication of the failure.

### TECHNICAL FIELD

The present disclosure relates in general to information handling systems, and more particularly to methods and systems for managing information handling systems in a datacenter environment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In some situations, a datacenter or other environment may have one or more compliance regimes that must be satisfied by the information handling systems therein. For example, security compliance requirements may be requested or required by governments, regulatory boards, customers, and/or internal company processes. Ensuring compliance typically requires administrative, physical, and technical safeguards to be put in place. Of these, the technical or IT-related safeguards may be the most difficult to monitor and control, due in part to the dynamic nature of hardware and software components of information handling systems in a datacenter.

Meeting security compliance policies has typically required organizations to conduct manual certification exercises at frequent intervals, which is costly in terms of both time and resources. Hardware, firmware, and software changes exacerbate the need for frequent manual certification exercises, as do any changes in the compliance requirements themselves. The lack of a standardized and automated compliance verification framework also leads to frequent non-compliance scenarios.

This disclosure provides techniques that may be employed to assist management of information handling systems in these and other situations.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with managing information handling systems in a datacenter environment may be reduced or eliminated.

In accordance with embodiments of the present disclosure, an information handling system may include at least one processor, a non-transitory memory coupled to the at least one processor, and an information handling resource coupled to the at least one processor. The information handling system may have an encryption key associated therewith. The information handling system may be configured to receive a compliance template that includes security attributes of the information handling resource, the security attributes including information regarding the encryption key. The information handling system may further be configured to, based on the compliance template and a compliance standard, determine a set of compliance tests for the information handling resource. The information handling system may be further configured to execute the set of compliance tests, and, in response to a failure of at least one test of the set of compliance tests, provide an indication of the failure.

In these and other embodiments, a method may include, at an information handling system that includes an information handling resource, receiving a compliance template that includes security attributes of the information handling resource. The method may further include, based on the compliance template and a compliance standard, the information handling system determining a set of compliance tests for the information handling resource. The method may further include the information handling system executing the set of compliance tests, and, in response to a failure of at least one test of the set of compliance tests, the information handling system providing an indication of the failure.

In these and other embodiments, an article of manufacture may include a non-transitory, computer-readable medium having instructions store thereon, the instructions being executable by at least one processor of an information handling system. The instructions may be executable for receiving a compliance template that includes security attributes of an information handling resource of the information handling system; based on the compliance template and a compliance standard, determining a set of compliance tests for the information handling resource; executing the set of compliance tests; and in response to a failure of at least one test of the set of compliance tests, the information handling system providing an indication of the failure.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with some embodiments of the present disclosure;

FIG. 2 illustrates a flow chart of an example framework, in accordance with some embodiments of the present disclosure;

FIG. 3 illustrates a code listing, in accordance with some embodiments of the present disclosure; and

FIG. 4 illustrates a flow chart of an example method, in accordance with some embodiments of the present disclosure.

### DETAILED DESCRIPTION

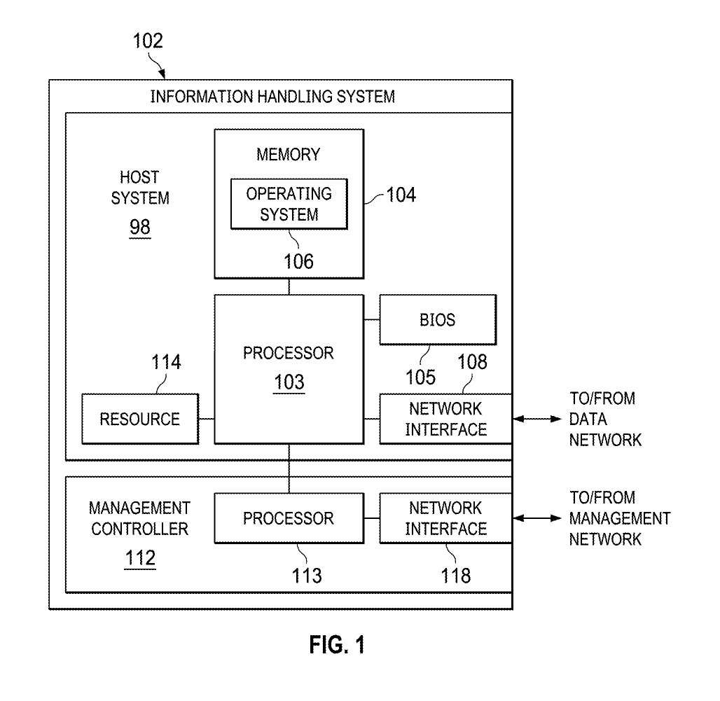

Preferred embodiments and their advantages are best understood by reference to FIGS. 1 through 4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected indirectly or directly, with or without intervening elements. When two or more elements are referred to as “coupleable” to one another, such term indicates that they are capable of being coupled together.

For the purposes of this disclosure, computer-readable media (e.g., transitory or non-transitory computer-readable media) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102. In some embodiments, information handling system 102 may comprise a personal computer. In some embodiments, information handling system 102 may comprise or be an integral part of a server. In other embodiments, information handling system 102 may comprise a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a BIOS 105 communicatively coupled to processor 103, a network interface 108 communicatively coupled to processor 103, and a management controller 112 communicatively coupled to processor 103.

Information handling system 102 may also include one or more information handling resources 114 communicatively coupled to processor 103. As described in further detail below, the operational state of information handling resources 114 may implicate any of various compliance standards. Thus, the ability to determine such operational states and how they relate to the compliance standards of interest may be beneficial.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., disk drives) may be executed by processor 103 and given control of information handling system 102. In some embodiments, BIOS 105 may be used for network booting of a client information handling system from a server information handling system (e.g., via network interface 108).

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

In operation, processor 103, memory 104, BIOS 105, and network interface 108 may comprise at least a portion of a host system 98 of information handling system 102.

Management controller 112 may be configured to provide management facilities for management of information handling system 102. Such management may be made by management controller 112 even if information handling system 102 and/or host system 98 are powered off or powered to a standby state. Management controller 112 may include a processor 113, memory, and a management network interface 118 separate from and physically isolated from data network interface 108. In certain embodiments, management controller 112 may include or may be an integral part of a baseboard management controller (BMC), a chassis management controller (CMC), or a remote access controller (e.g., a Dell Remote Access Controller or Integrated Dell Remote Access Controller). In some embodiments, a plurality of host systems 98 may be present in information handling system 102, and management controller 112 may provide management of any or all of such host systems 98.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network 108, or in other embodiments it may be a device of a different type.

In operation, information handing system 102 or any information handling resource thereof may be subject to one or more compliance standards, which typically set out requirements related to security practices, software versions, cryptographic algorithms, etc. Compliance standards are most typically applied to server computers and other hardware in datacenters (e.g., routers, switches, etc.), but one of ordinary skill with the benefit of this disclosure will understand that the techniques herein may be applied in other contexts as well.

The techniques disclosed herein may be applied in the context of any of various compliance standards. In some instances, a single information handling system may be subject to more than one compliance standard, e.g., as a multi-function server or due to virtualization. Non-limiting examples of such standards may include those specified by the Payment Card Industry Data Security Standard (PCI DSS), the Health Insurance Portability and Accountability Act (HIPAA), the International Traffic in Arms Regulations (ITAR), the Federal Information Processing Standard (FIPS), and the National Institute of Standards and Technology (NIST). Other terms and acronyms used herein will be understood by one of ordinary skill in the art with the benefit of this disclosure, and may include Open Vulnerability and Assessment Language (OVAL), Security Content Automation Protocol (SCAP), and Extensible Configuration Checklist Description Format (XCCDF).

As one example of a compliance standard, FIPS Publication 140-2 is attached as Appendix A to the specification and is incorporated by reference in its entirety. An excerpt of FIPS Publication 140-2 is also shown below at Table 1 for purposes of general context and understanding of the types of requirements that a particular compliance standard might impose on an information handling system or information handling resource.

TABLE 1

| | Security Level 1 | Security Level 2 | Security Level 3 | Security Level 4 |
|---|---|---|---|---|
| Cryptographic | Specification of cryptographic module, cryptographic boundary, Approved algorithms, and Approved modes of operation. | | | |
| Module | Description of cryptographic module, including all hardware, software, and firmware components. | | | |
| Specification | Statement of module security policy. | | | |
| Cryptographic | Required and optional interfaces. Specification of | | Data ports for unprotected critical security parameters | |
| Module Ports | all interfaces and of all input and output data paths. | | logically or physically separated from other data ports. | |
| and Interfaces | | | | |
| Roles, | Logical separation of | Role-based or identity-based | Identity-based operator authentication. | |
| Services, and | required and optional | operator authentication. | | |
| Authentication | roles and services. | | | |
| Finite State | Specification of finite state model. Required states and optional states. State transition diagram and specification of state transitions. | | | |
| Model | | | | |
| Physical | Production grade | Locks or tamper evidence. | Tamper detection and response | Tamper detection and response |
| Security | equipment. | | for covers and doors. | envelope. EFP or EFT. |
| Operational | Single operator. | Referenced PPs evaluated at | Referenced PPs plus | Referenced PPs plus trusted |
| Environment | Executable code. | EAL2 with specified | trusted path evaluated | path evaluated at EAL4. |
| | Approved integrity | discretionary access control | at EAL3 plus security | |
| | technique. | mechanisms and auditing. | policy modeling. | |
| Cryptographic | Key management mechanisms; random number and key generation, key establishment, key distribution, key entry/output, key storage, | | | |
| Key | and key zeroization. | | | |
| Management | | | | |
| | Secret and private keys established using manual methods may be | | Secret and private keys established using manual methods shall be | |
| | entered or output in plaintext form. | | entered or output encrypted or with split knowledge procedures. | |
| EMI/EMC | 47 CFR FCC Part 15, Subpart B, Class A (Business use). | | 47 CFR FCC Part 15, Subpart B, Class B (Home use). | |
| | Applicable FCC requirements (for radio). | | | |
| Self-Tests | Power-up tests: cryptographic algorithm tests, software/firmware integrity tests, critical functions tests. Conditional tests. | | | |
| Design | Configuration management | CM system. Secure | High-level language | Formal model. Detailed |
| Assurance | (CM). Secure installation | distribution. Functional | implementation. | explanations (informal proofs). |
| | and generation. Design and | specification. | | Preconditions and post- |
| | policy correspondence. | | | conditions. |
| | Guidance documents. | | | |

| | |
|---|---|
| Mitigation of | Specification of mitigation of attacks for which no testable requirements are currently available. |
| Other Attacks | |

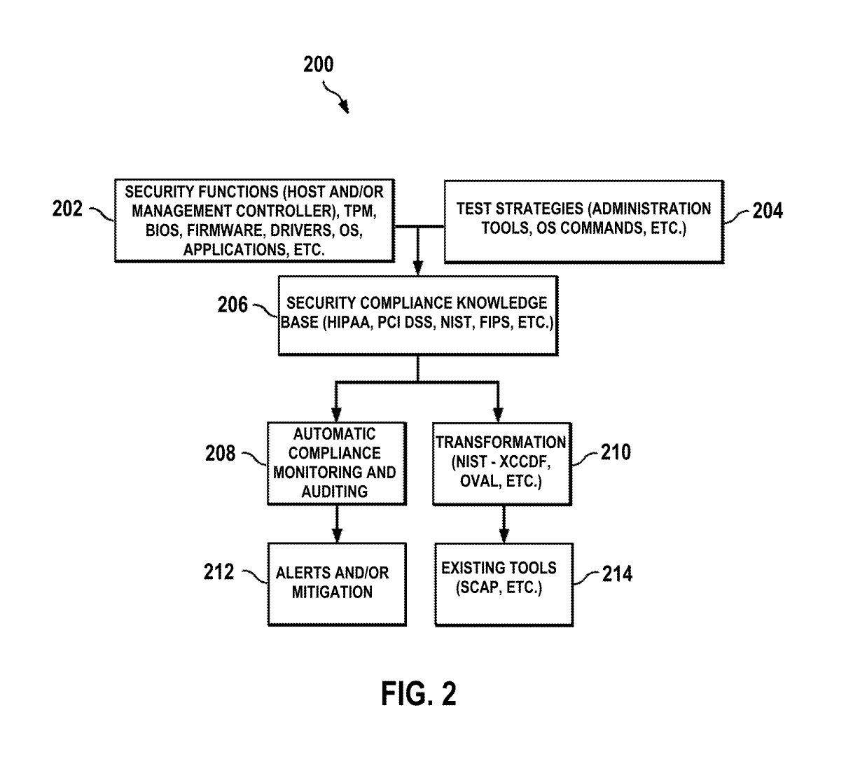

Turning now to FIG. 2, an embodiment of a flow chart 200 is shown which may be used to implement various aspects of the present disclosure.

Security functions 202 may describe a comprehensive list of the various security-related capabilities of an information handling system. For example, security functions 202 may include functions available via host system 98 and/or functions available via management controller 112. Security functions 202 may be accessible via a Trusted Platform Module (TPM), BIOS or other firmware, drivers, an operating system, application programs, or any other suitable manner. Test strategies 204 describe interface details and available testing methods that may be used in mapping security functions 202 with system management capabilities. Test strategies 204 may in some embodiments be implemented via existing administration tools, including standard operating system commands. For example, commands may be executed on a host system or a management controller, relevant registry entries may be read to determine software versions, etc. In some embodiments, management controller 112 may be a chassis management controller that may be configured to provide out-of-band management and compliance testing for a plurality of host systems.

As shown in FIG. 2, security functions 202 and test strategies 204 may be integrated into security compliance knowledge base 206. Security compliance knowledge base 206 may include templates describing how the available test strategies in a given information handling system may be used to test the security functions that are present in that information handling system. In some embodiments, such templates may be specific as to a particular compliance standard. In other embodiments, a template may be applicable across a plurality of compliance standards.

Templates in security compliance knowledge base 206 may be implemented as a set of rules that may subsequently be executed by a rules engine in performing compliance testing. As one example, a template may include rules specifying how to test whether a particular cryptographic function or cryptographic key in use at an information handling system or information handling resource is subject to any known vulnerabilities. For example, the rule might indicate an internet address which contains up-to-date information regarding cryptographic flaws, affected versions of known implementations, etc. In this way, the rule may specify a test strategy for verifying the security properties of such a cryptographic system.

In some embodiments, the templates in security compliance knowledge base 206 may be created manually by security experts and/or systems management experts. In other embodiments, automated tools may be used. In yet other embodiments, templates may be created manually, and tools may be used to automatically update such templates in response to changes (e.g., minor changes) in compliance standards.

Security compliance knowledge base 206 and the templates therein may be used at step 208 for automatic compliance monitoring and auditing. For example, compliances may be monitored over time as firmware updates, driver updates, etc. create changes in the information handling system. Such monitoring may occur on demand, periodically, in response to a hardware or software change, or based on any other desired schedule. The results of the automatic compliance monitoring and auditing may be used for alerts and/or mitigation at step 212. For example, if an information handling resource fails a test during automatic compliance monitoring and auditing, an alert may be sent to a system administrator; alternatively or in addition, mitigation may automatically be initiated. For example, if a test failed based on an out-of-date firmware being detected, the firmware may be automatically updated in some embodiments to bring it into compliance.

In some embodiments, alternatively or in addition, the templates of security compliance knowledge base 206 may be transformed at step 210 into a format usable by existing tools. A transformation utility may provide a method to generate code according to various industry-standard security compliance formats (XCCDF, OVAL, etc.) from the templates in security compliance knowledge base 206. At step 214, such existing tools may be used to analyze the information handling system based on the transformed template.

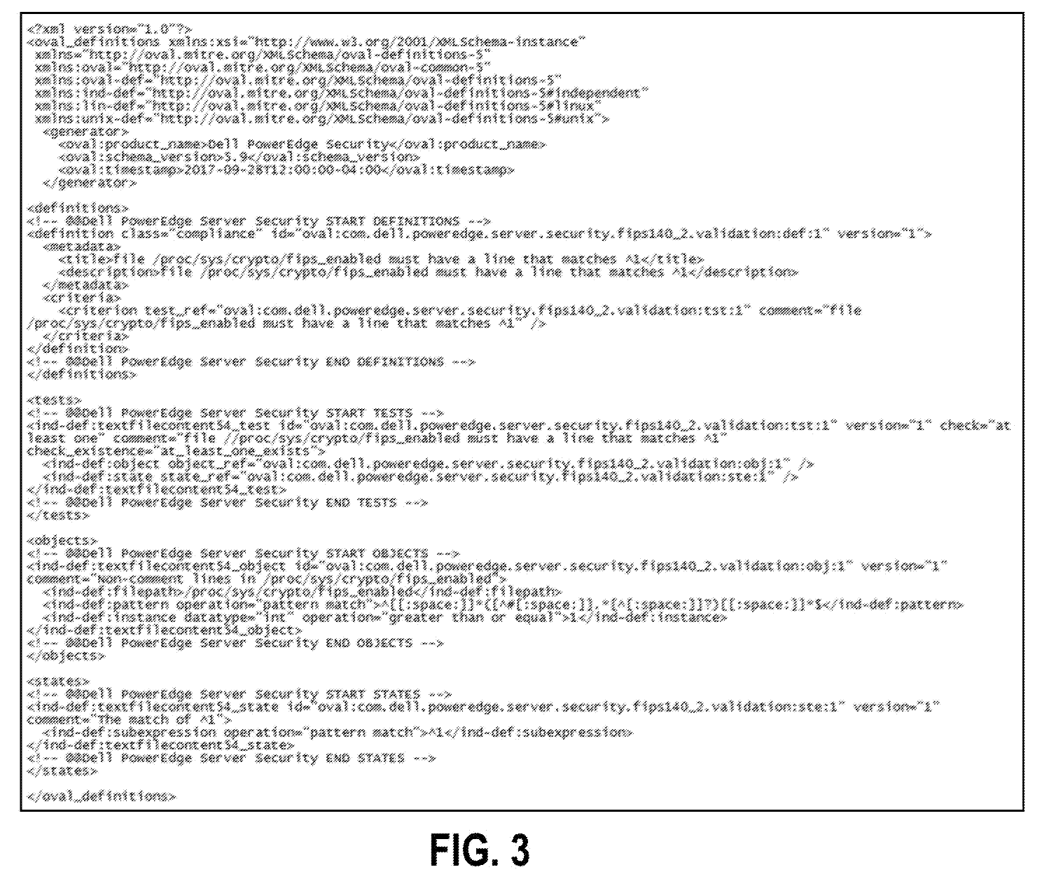

Turning now to FIG. 3, an excerpt of an example code listing is shown, such as might be generated at transformation step 210 of FIG. 2. In particular, FIG. 3 depicts a sample XML file including an OVAL definition that may be used in implementing compliance testing for a particular information handling system (a Dell PowerEdge Server) and a particular standard (FIPS). As shown in FIG. 3, various definitions, tests, objects, and states may be encoded into a computer-readable format that may be used with, for example, existing SCAP-compliant tools. One of ordinary skill in the art with the benefit of this disclosure will understand various other ways of encoding such information, additional or alternative information that might be desired to be included, etc.

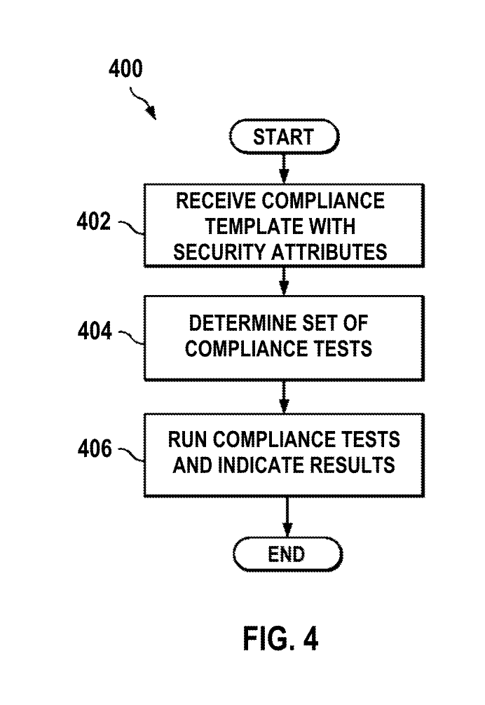

Turning now to FIG. 4, a flow chart of an example method 400 is shown for performing compliance monitoring, in accordance with certain embodiments of the present disclosure. According to some embodiments, method 400 may begin at step 402. As noted above, teachings of the present disclosure may be implemented in a variety of configurations, such as within the context of information handling systems 102.

At step 402, a compliance template is received which includes security attributes for an information handling system. Security attributes in the compliance template may include information regarding security functions implemented at the information handling system and/or test strategies available at the information handling system, as discussed above with regard to FIG. 2.

At step 404, a set of compliance tests may be determined. The tests may be determined in accordance with the security attributes, as well as a particular compliance standard for which compliance is to be tested.

At step 406, the compliance tests in the set of compliance tests are run, and the results are indicated. For example, notifications of failure or success may be sent to a system administrator. In some embodiments of a failing test, an automatic mitigation procedure may also be initiated (e.g., a software or firmware update may be downloaded and/or installed).

After step 406, method 400 may end.

Although FIG. 4 discloses a particular number of steps to be taken with respect to method 400, method 400 may be executed with greater or lesser steps than those depicted in FIG. 4. In addition, although FIG. 4 discloses a certain order of steps to be taken with respect to method 400, the steps comprising method 300 may be completed in any suitable order.

Method 400 may be implemented using information handling system 102 or any other system operable to implement method 400. In certain embodiments, method 400 may be implemented partially or fully in software and/or firmware embodied in computer-readable media.

Various embodiments of the present disclosure have been described above. In these and other embodiments, additional features may also be present. For example, in some embodiments, a “base” compliance template may be generated at the factory when an information handling system is built. Such a base template may be generated based on key security functions such as cryptographic algorithms, ciphers, TPM attributes, BIOS security attributes, firmware versions etc. In some embodiments, the base template may be generated via pre-configured meta-data. Each function may also be complemented with a “test” or a checking strategy that can be used to validate compliance at a later point of time, when required. Examples may include specific RACADM, Redfish/WSMAN commands, etc.

In these and other embodiments, at the time of OS deployment, the “base” compliance template that dealt with hardware-related security compliance aspects may be extended to include OS-specific requirements, such as key driver versions, available SSL and cryptographic algorithms, SELinux enablement, etc. Validation functions as part of this step may be executing OS-specific commands, application (Ex. OpenSSL) specific security APIs, OMSA OMCLI commands, etc.

In these and other embodiments, a “library” of templates for key security compliances may be published, capturing required attributes to be validated, for some of the common certifications in use. These templates may be modified at the customer site, for example based on unique or additional checks to be performed, hardware customizations, etc. Such modifications may typically be done in consultation with a security expert and an IT administrator, to create a version of the template that is unique to the datacenter setup being certified.

In these and other embodiments, the “specialized” version of a template can be interpreted by a management controller and executed to capture current values of specified attributes, e.g., via the management controller, the BIOS, and/or the host. Current values of these attributes may be evaluated against expected values to check and report for adherence to or deviations from a certification.

In these and other embodiments, 1×N consoles may be used to manage compliance templates, and run periodic compliance checks against monitored devices by pushing them to the corresponding management controller. For host systems that may not have a management controller, the console may execute “remote” commands to validate key compliance requirements, provided such commands exist and are captured in the template. Alternatively, templates may also be used with industry-standard SCAP tools to monitor compliances periodically against changes in system configurations (firmware, hardware component replacements, software security functions, etc.).

In these and other embodiments, this disclosure also provides for transformation mechanisms to various U.S. government standards such as NIST-approved SCAP compliance XCCDF, OVAL format, etc., allowing the templates to run on governmentally approved tools or scanners.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a non-transitory memory coupled to the at least one processor; and
an information handling resource coupled to the at least one processor and having an encryption key associated therewith;
wherein the information handling system is configured to:
receive a compliance template that includes security attributes of the information handling resource, the security attributes including information regarding the encryption key;
based on the compliance template and a compliance standard, determine a set of compliance tests for the information handling resource;
execute the set of compliance tests; and
in response to a failure of at least one test of the set of compliance tests, provide an indication of the failure.

2. The information handling system of claim 1, wherein in response to the failure of the at least one test, the information handling system is further configured to update a software and/or a firmware of the information handling resource.

3. The information handling system of claim 1, wherein in response to the failure of the at least one test, the information handling system is further configured to update the encryption key of the information handling resource.

4. The information handling system of claim 1, wherein the information handling system is a host information handling system that further comprises a management controller, the management controller being configured to provide out-of-band management of the information handling system.

5. The information handling system of claim 1, further comprising a Trusted Platform Module, wherein the Trusted Platform Module is configured to facilitate execution of the set of compliance tests.

6. The information handling system of claim 1, wherein the information handling system is a management controller configured to provide out-of-band management of a host information handling system, and wherein the host information handling system comprises the information handling resource.

7. The information handling system of claim 6, wherein the management controller is a chassis management controller configured to provide out-of-band management of a plurality of host information handling systems.

8. The information handling system of claim 1, wherein the set of compliance tests includes at least one test configured to verify at least one of a firmware version, a driver version, or an operating system patch level.

9. A method comprising:
at an information handling system that includes an information handling resource, receiving a compliance template that includes security attributes of the information handling resource;
based on the compliance template and a compliance standard, the information handling system determining a set of compliance tests for the information handling resource;
the information handling system executing the set of compliance tests; and
in response to a failure of at least one test of the set of compliance tests, the information handling system providing an indication of the failure.

10. The method of claim 9, wherein the compliance template is further based on a mapping between inventory details of a baseline configuration of the information handling system and security functions of the information handling system, and wherein the compliance template facilitates execution of the set of compliance tests.

11. The method of claim 9, further comprising:
continuously monitoring the information handling system for a hardware and/or software change.

12. The method of claim 9, further comprising updating the compliance template in response to a change in the compliance standard.

13. The method of claim 9, wherein the set of compliance tests includes at least one test configured to verify a version of an application program stored by the information handling system.

14. An article of manufacture including a non-transitory, computer-readable medium having instructions store thereon, the instructions being executable by at least one processor of an information handling system for:
receiving a compliance template that includes security attributes of an information handling resource of the information handling system;
based on the compliance template and a compliance standard, determining a set of compliance tests for the information handling resource;
executing the set of compliance tests; and
in response to a failure of at least one test of the set of compliance tests, the information handling system providing an indication of the failure.

15. The article of claim 14, wherein the compliance template includes information regarding an encryption key associated with the information handling resource.

16. The article of claim 14, wherein the instructions are further executable for, in response to the failure of at least one test, updating a software and/or a firmware associated with the information handling resource.

17. The article of claim 14, wherein the instructions are further executable for, in response to the failure of at least one test, updating an encryption key associated with the information handling resource.

18. The article of claim 14, wherein the set of compliance tests includes at least one test configured to verify at least one of a firmware version, a driver version, or an operating system patch level.

19. The article of claim 14, wherein the compliance template is created manually.

20. The article of claim 14, wherein the security attributes include security functions implemented at the information handling system and test strategies available at the information handling system.
